(19) United States
(12) Patent Application Publication
(10) Pub. No.: US 2022/0346471 A1
(43) Pub. Date: Nov. 3, 2022

(54) SUPER WATER-REPELLENT MASK HAVING NANO PATTERNED STRUCTURE ON ITS SURFACE

(71) Applicant: KOREA INSTITUTE OF SCIENCE AND TECHNOLOGY, Seoul (KR)

(72) Inventors: Myoung-Woon Moon, Seoul (KR); Sang-jin Park, Seoul (KR); YOUNG A LEE, Seoul (KR); Hyseung Cho, Seoul (KR); Cho-hee Lee, Seoul (KR); Sunmi Yoon, Seoul (KR)

(73) Assignee: KOREA INSTITUTE OF SCIENCE AND TECHNOLOGY, Seoul (KR)

(21) Appl. No.: 17/730,863

(22) Filed: Apr. 27, 2022

(30) Foreign Application Priority Data
Apr. 29, 2021 (KR) 10-2021-0055756

(51) Int. Cl. A41D 13/11

(52) U.S. Cl. CPC A41D 13/11

(57) ABSTRACT

The present disclosure relates to an anti-droplet mask filter and an anti-droplet mask comprising the same, and more particularly, to a hydrophobic filter having ridges and an anti-droplet mask comprising the same. The present disclosure is directed to providing a mask filter with improved water repellency performance for effectively preventing the spread of acute respiratory syndrome virus infections.

The super water-repellent anti-droplet nonwoven filter of the present disclosure shows superhydrophobicity with the surface contact angle of 160° or more due to the ridges that form a nanopatterned structure on the surface of hydrophobic fibers and the surface of bonding portions, thereby preventing the adsorption of droplets onto the surface of the filter. Additionally, the super water-repellent anti-droplet nonwoven filter of the present disclosure can capture ultrafine particles such as aerosols due to the nanopatterned structure on the surface of the super water-repellent anti-droplet nonwoven filter.

### CROSS-REFERENCE TO RELATED APPLICATION

This application claims priority to Korean Patent Application No. 10-2021-0055756, filed on Apr. 29, 2021, and all the benefits accruing therefrom under 35 U.S.C. § 119, the contents of which in its entirety are herein incorporated by reference.

### BACKGROUND

### 1. Field

The present disclosure relates to an anti-droplet mask, and more particularly, to a super water-repellent anti-droplet mask having a nanopatterned structure on its surface.

### 2. Description of the Related Art

The repeated spread of acute respiratory syndrome virus infections such as coronavirus disease-19 (COVID-19), middle east respiratory syndrome (MERS) and severe acute respiratory syndrome (SARS) is of grave concern. In particular, COVID-19 is a human coronavirus disease and was first detected in Wuhan, Hubei Province, China, in December 2019. The coronavirus is a RNA virus which causes respiratory diseases including influenza. The coronavirus is named for the crown (Latin corona) of spikes covering the outer membrane. The coronavirus causes infectious diseases in a variety of animals including humans.

The respiratory syndrome is primarily transmitted through an infected person's droplets (respiratory saliva droplets). According to the World Health Organization (WHO), a droplet refers to a light water drop having the diameter of more than 5 μm, and a small water particle having the diameter of less than 5 μm is defined as an aerosol. The respiratory syndrome is transmitted between people, and most of infections are caused by close contact with droplets produced when an infected person coughs, sneezes, talks or sings. According to the research findings, in addition to the droplets, the respiratory syndrome may be transmitted via surface contact, air, etc., but it is known that air transmission restrictively occurs in aerosol generating medical procedures and specific environments, for example, environments for producing respiratory droplets in closed spaces for a long time.

Since the respiratory syndrome spread through droplets containing virus, anti-droplet masks are identified as the most effective means for preventing and slowing down the spread of the respiratory syndrome.

However, the existing anti-droplet masks have a problem that droplet particles are deposited on the surface of the masks, so there is a need for masks with improved water repellency.

### RELATED LITERATURES

Related Literature 1: Korean Patent No. 10-2082969, titled fine dust mask treated with plasma

Related Literature 2: Korean Patent Publication No. 10-2018-0074677, titled plasma treatment of filtration media for smoking articles

### SUMMARY

The present disclosure is directed to providing a mask with improved anti-droplet performance for effectively preventing the spread of acute respiratory syndrome virus infections.

To achieve the above-described object, the present disclosure provides a super water-repellent anti-droplet mask including an outer filter including a hydrophobic nonwoven fabric composed of bundles of hydrophobic fibers with first ridges that form a nanopatterned structure on a surface of the hydrophobic fibers; an intermediate filter including a melt-blown nonwoven fabric composed of bundles of melt-blown fibers with second ridges that form a nanopatterned structure on a surface of the melt-blown fibers; and an inner filter including a hydrophilic nonwoven fabric composed of bundles of hydrophilic fibers with third ridges that form a nanopatterned structure on a surface of the hydrophilic fibers.

Additionally, to achieve the above-described object, the present disclosure provides a super water-repellent anti-droplet mask including an outer filter including a hydrophobic nonwoven fabric composed of bundles of hydrophobic fibers with first ridges that form a nanopatterned structure on a surface of the hydrophobic fibers; and an inner filter including a hydrophilic nonwoven fabric composed of bundles of hydrophilic fibers with third ridges that form a nanopatterned structure on a surface of the hydrophilic fibers.

Additionally, to achieve the above-described object, the present disclosure provides a super water-repellent anti-droplet mask including an outer filter including a hydrophobic nonwoven fabric composed of bundles of hydrophobic fibers with first ridges that form a nanopatterned structure on a surface of the hydrophobic fibers; an intermediate filter including a melt-blown nonwoven fabric composed of bundles of melt-blown fibers; and an inner filter including a hydrophilic nonwoven fabric composed of bundles of hydrophilic fibers with third ridges that form a nanopatterned structure on a surface of the hydrophilic fibers.

More preferably, the hydrophobic nonwoven fabric of the present disclosure may further include hydrophobic bonding portions to bind the bundles of hydrophobic fibers to form a web, and the hydrophobic bonding portions may have fourth ridges that form a nanopatterned structure on a surface of the hydrophobic bonding portions.

More preferably, the outer filter including the hydrophobic nonwoven fabric of the present disclosure may have a contact angle of 160° or more on a surface of the outer filter.

More preferably, the first ridges of the present disclosure may form a nanopatterned structure of nanowalls or nanopillars. More preferably, the first ridges of the present disclosure may be formed by plasma treatment. Additionally, more preferably, the plasma treatment of the first ridges of the present disclosure may be performed in the presence of at least one type of gas selected from O₂, CF₄, Ar, N₂ and H₂.

More preferably, the second ridges of the present disclosure may form a nanopatterned structure of nanowalls or nanopillars. More preferably, the second ridges of the present disclosure may be formed by plasma treatment. Additionally, more preferably, the plasma treatment of the second ridges of the present disclosure may be performed in the presence of at least one type of gas selected from O₂, CF₄, Ar, N₂, and H₂.

More preferably, the third ridges of the present disclosure may form a nanopatterned structure of nanowalls or nanopillars. More preferably, the third ridges of the present disclosure may be formed by plasma treatment. Additionally, more preferably, the plasma treatment of the third ridges of the present disclosure may be performed in the presence of at least one type of gas selected from O₂, CF₄, Ar, N₂ and H₂.

More preferably, the fourth ridges of the present disclosure may form a nanopatterned structure of nanowalls or nanopillars. More preferably, the fourth ridges of the present disclosure may be formed by plasma treatment. Additionally, more preferably, the plasma treatment of the fourth ridges of the present disclosure may be performed in the presence of at least one type of gas selected from O₂, CF₄, Ar, N₂ and H₂.

The outer filter made of the hydrophobic nonwoven fabric of the present disclosure shows superhydrophobicity with the surface contact angle of 160° or more due to the ridges that form the nanopatterned structure on the surface of the hydrophobic fibers and the surface of the bonding portions, thereby preventing the adsorption of droplets onto the surface of the filter. Additionally, the outer filter made of the hydrophobic nonwoven fabric of the present disclosure can capture ultrafine particles such as aerosols due to the nanopatterned structure on the surface of the super water-repellent anti-droplet nonwoven filter.

The intermediate filter made of the melt-blown nonwoven fabric of the present disclosure has improved performance of capture of not only droplet particles but also ultrafine particles such as aerosols due to the ridges that form the nanopatterned structure on the surface of the melt-blown fibers.

The inner filter made of the hydrophilic nonwoven fabric of the present disclosure is easy to absorb exhaled water vapor and saliva due to the ridges that form the nanopatterned structure on the surface of the hydrophilic fibers and the lobed cross section of the hydrophilic fibers provides soft feel on the skin.

### BRIEF DESCRIPTION OF THE DRAWINGS

The accompanying drawings illustrate a preferred embodiment of the present disclosure, and together with the detailed description, serve to provide a further understanding of the technical spirit of the present disclosure, and thus the present disclosure should not be construed as being limited to the drawings.

FIG. 1 is a cross-sectional view of a tri-layered mask including an outer filter, an intermediate filter and an inner filter according to an embodiment of the present disclosure.

FIG. 2 is a scanning electron microscopy (SEM) image showing the surface of hydrophobic fibers of an outer filter having first ridges on the surface according to an embodiment of the present disclosure.

FIG. 3 is a photographic image showing a comparison of hydrophobic performance through a dipping test between a hydrophobic nonwoven outer filter without ridges and a hydrophobic nonwoven outer filter with first and fourth ridges according to an embodiment of the present disclosure.

FIG. 4 is a photographic image showing a comparison of contact angle of surface between a hydrophobic nonwoven outer filter without ridges and a hydrophobic nonwoven outer filter with first ridges according to an embodiment of the present disclosure.

FIG. 5 is a photographic image showing a comparison of residual droplets between a hydrophobic nonwoven outer filter without ridges and a hydrophobic nonwoven outer filter with first ridges according to an embodiment of the present disclosure.

FIG. 6 is a photographic image showing a comparison of fluorescent particle coating test results between a hydrophobic nonwoven outer filter without ridges and a hydrophobic nonwoven outer filter with first ridges according to an embodiment of the present disclosure.

FIG. 7 is an SEM image showing a comparison of surfaces between a melt-blown (MB) nonwoven intermediate filter without ridges and a melt-blown nonwoven intermediate filter with second ridges according to an embodiment of the present disclosure.

FIG. 8 is an SEM image showing a comparison of the degree of nanoparticle adsorption between a melt-blown nonwoven intermediate filter without ridges and a melt-blown nonwoven intermediate filter with second ridges according to an embodiment of the present disclosure.

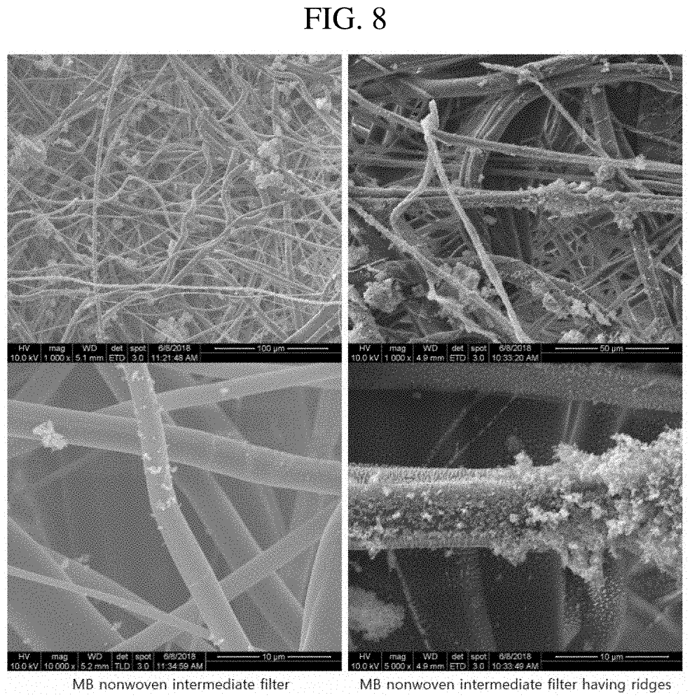

FIG. 9 is an SEM image showing the surfaces of a hydrophilic nonwoven inner filter without ridges and a hydrophilic nonwoven inner filter with third ridges according to an embodiment of the present disclosure.

FIG. 10 is a photographic image showing the experimental results of measuring the liquid absorption time for each of a hydrophilic nonwoven inner filter without ridges and a hydrophilic nonwoven inner filter with third ridges according to an embodiment of the present disclosure.

FIG. 11 shows the experimental results of measuring the degree of liquid absorption for each of a hydrophilic nonwoven inner filter without ridges and a hydrophilic nonwoven inner filter with third ridges according to an embodiment of the present disclosure.

### DETAILED DESCRIPTION

Hereinafter, the present disclosure will be described in detail with reference to the accompanying drawings. The terms or words used in the specification and the appended claims should not be construed as being limited to general and dictionary meanings, but rather interpreted based on the meanings and concepts corresponding to the technical spirit of the present disclosure on the basis of the principle that the inventor is allowed to define the terms appropriately for the best explanation.

To achieve the above-described object, the present disclosure provides a super water-repellent anti-droplet mask including an outer filter including a hydrophobic nonwoven fabric composed of bundles of hydrophobic fibers with first ridges that form a nanopatterned structure on the surface of the hydrophobic fibers; an intermediate filter including a melt-blown nonwoven fabric composed of bundles of melt-blown fibers with second ridges that form a nanopatterned structure on the surface of the melt-blown fibers; and an inner filter including a hydrophilic nonwoven fabric composed of bundles of hydrophilic fibers with third ridges that form a nanopatterned structure on the surface of the hydrophilic fibers.

Additionally, to achieve the above-described object, the present disclosure provides a super water-repellent anti-droplet mask including an outer filter including a hydrophobic nonwoven fabric composed of bundles of hydrophobic fibers with first ridges that form a nanopatterned structure on the surface of the hydrophobic fibers; and an inner filter including a hydrophilic nonwoven fabric composed of bundles of hydrophilic fibers with third ridges that form a nanopatterned structure on the surface of the hydrophilic fibers.

Additionally, to achieve the above-described object, the present disclosure provides a super water-repellent anti-droplet mask including an outer filter including a hydrophobic nonwoven fabric composed of bundles of hydrophobic fibers with first ridges that form a nanopatterned structure on the surface of the hydrophobic fibers; an intermediate filter including a melt-blown nonwoven fabric composed of bundles of melt-blown fibers; and an inner filter including a hydrophilic nonwoven fabric composed of bundles of hydrophilic fibers with third ridges that form a nanopatterned structure on the surface of the hydrophilic fibers.

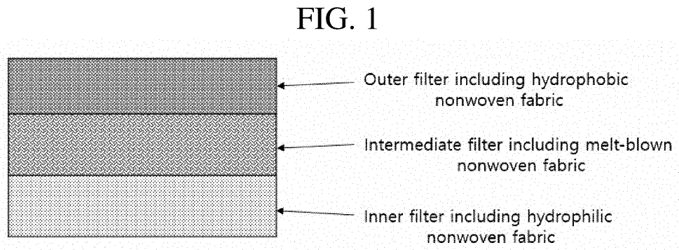

Referring to FIG. 1, it includes three layers of an outer filter, an intermediate filter and an inner filter according to an embodiment the present disclosure. The outer filter is made of a hydrophobic nonwoven fabric to prevent outdoor droplets from penetrating the mask. The intermediate filter is made of a melt-blown nonwoven fabric and serves to capture fine dust and droplets (or virus particles in the droplets). The inner filter including a hydrophilic nonwoven fabric plays a role in absorbing exhaled water vapor and saliva in a wearer's breath and preventing skin irritation.

Since the outer filter of the present disclosure is a hydrophobic nonwoven fabric composed of bundles of hydrophobic fibers having first ridges that form a nanopatterned structure on the surface of the hydrophobic fibers, the hydrophobic surface shows superhydrophobicity due to the first ridges of the nanopatterned structure. Due to the hydrophobic ridges of the nanopatterned structure on the surface of the hydrophobic fibers, the contact with water is minimized, thereby achieving super water-repellency against droplets.

The outer filter made of the hydrophobic nonwoven fabric of the present disclosure shows superhydrophobicity with the surface contact angle of 160° or more due to the ridges that form the nanopatterned structure on the surface of the hydrophobic fibers and the surface of bonding portions, thereby preventing the adsorption of droplets onto the surface of the filter. Additionally, the outer filter made of the hydrophobic nonwoven fabric of the present disclosure can capture ultrafine particles such as aerosols due to the nanopatterned structure on the surface of the super water-repellent anti-droplet nonwoven filter.

More preferably, the outer filter made of the hydrophobic nonwoven fabric may further include hydrophobic bonding portions to bind the bundles of hydrophobic fibers to form a web, and the hydrophobic bonding portions may have fourth ridges that form a nanopatterned structure on the surface of the hydrophobic bonding portions.

As the outer filter of the present disclosure also has the fourth ridges of the nanopatterned structure on the surface of the bonding portions that may be potentially contaminated by droplets, it is possible to improve droplet repellency.

More preferably, the outer filter including the hydrophobic nonwoven fabric of the present disclosure may have the contact angle of 160° or more on the surface of the outer filter. A common hydrophobic surface has the contact angle of less than 140°, but the hydrophobic nonwoven outer filter having the ridges that form the nanopatterned structure of the present disclosure has the contact angle of 160° or more and thus shows superhydrophobic properties.

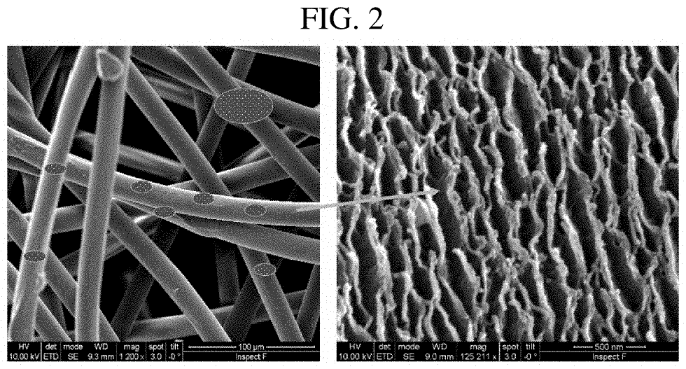

More preferably, the first ridges of the present disclosure may form a nanopatterned structure of nanowalls or nanopillars. Referring to FIG. 2, it can be seen that the first ridges are in the shape of nanowalls. Additionally, the first ridges may be formed in the shape of nanopillars depending on the treatment method. The first ridges may have a diameter in the range of 1 to 100 nm, a length in the range of 1 to 10,000 nm, and an aspect ratio of 0.01 to 50.

More preferably, the first ridges of the present disclosure may be formed by plasma treatment.

The conditions of the plasma treatment and the treatment time may be adjusted to form the nanopatterned structure in various shapes.

Additionally, more preferably, the plasma treatment of the first ridges of the present disclosure may be performed in the presence of at least one type of gas selected from O₂, CF₄, Ar, N₂ and H₂.

Among them, when O₂ gas is used, the plasma treatment may create a hydrophobic surface having durability by the bond between the fiber surface and oxygen. In this instance, the pressure of the plasma treatment may be, for example, 1 to 1000 mTorr, and higher atmospheric pressure may be used. The plasma treatment may be performed, for example, in the voltage range of −100V to −1000V, and may be performed under the pressure of 1 to 1000 mTorr for 10 seconds to 5 hours.

More preferably, the fourth ridges of the present disclosure may form a nanopatterned structure of nanowalls or nanopillars. The fourth ridges may have a diameter in the range of 1 to 100 nm, a length in the range of 1 to 10,000 nm and an aspect ratio of 0.01 to 50. More preferably, the fourth ridges of the present disclosure may be formed by plasma treatment. Additionally, more preferably, the plasma treatment of the fourth ridges of the present disclosure may be performed in the presence of at least one type of gas selected from O₂, CF₄, Ar, N₂ and H₂.

The intermediate filter of the present disclosure includes a melt-blown nonwoven fabric composed of bundles of melt-blown fibers having second ridges that form a nanopatterned structure on the surface of the melt-blown fibers, and serves to capture fine dust and droplet particles using electrostaticity.

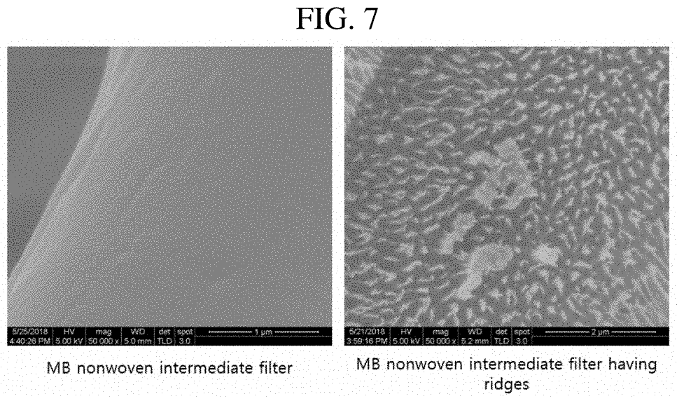

Referring to FIG. 7, the intermediate filter of the present disclosure has the second ridges that form the nanopatterned structure on the surface of the melt-blown fibers to form a multi-scale structure. Due to the ridges that form the nanopatterned structure on the surface of the melt-blown fibers, it is possible to improve the performance of capture of not only droplet particles but also ultrafine particles such as aerosols.

More preferably, the second ridges of the present disclosure may form a nanopatterned structure of nanowalls or nanopillars. The second ridges may have a diameter in the range of 1 to 100 nm, a length in the range of 1 to 10,000 nm and an aspect ratio of 0.01 to 50. More preferably, the second ridges of the present disclosure may be formed by plasma treatment. Additionally, more preferably, the plasma treatment of the second ridges of the present disclosure may be performed in the presence of at least one type of gas selected from O₂, CF₄, Ar, N₂ and H₂.

The inner filter of the present disclosure includes a hydrophilic nonwoven fabric composed of bundles of hydrophilic fibers having third ridges that form a nanopatterned structure on the surface of the hydrophilic fibers, and plays a role in absorbing exhaled water vapor and saliva in the wearer's breath and preventing skin irritation.

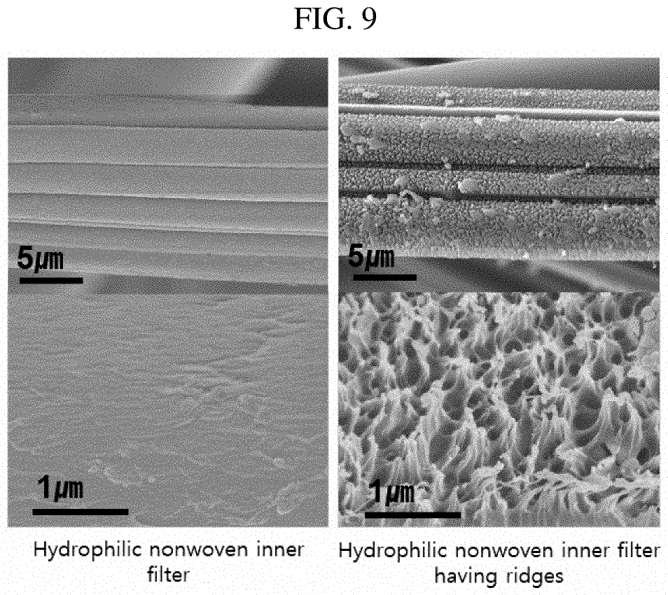

Referring to FIG. 9, the inner filter of the present disclosure has the third ridges that form the nanopatterned structure on the surface of the hydrophilic fibers to form a multi-scale structure. The ridges of the hydrophilic nanopatterned structure have a strong attraction to water molecules, and thus the inner filter shows superhydrophilicity, and liquid absorption occurs very rapidly. Additionally, it can be seen that clear grooves similar to artificial silk fibers are formed on the surface of the hydrophilic fibers, and due to the grooves similar to artificial silk fibers on the surface of the hydrophilic fibers, the contact area with the skin is minimized, thereby reducing discomfort and preventing the wet mask from attaching to the skin.

The inner filter made of the hydrophilic nonwoven fabric of the present disclosure is easy to absorb exhaled water vapor and saliva due to the ridges that form the nanopatterned structure on the surface of the hydrophilic fibers, and the lobed cross section of the hydrophilic fibers provides soft feel on the skin.

More preferably, the third ridges of the present disclosure may form a nanopatterned structure of nanowalls or nanopillars. The third ridges may have a diameter in the range of 0.01 to 100 nm, a length in the range of 1 to 10,000 nm and an aspect ratio of 1 to 50. More preferably, the third ridges of the present disclosure may be formed by plasma treatment. Additionally, more preferably, the plasma treatment of the third ridges of the present disclosure may be performed in the presence of at least one type of gas selected from O₂, CF₄, Ar, N₂ and H₂.

The present disclosure may provide the high performance mask for effectively responding to the respiratory syndrome through the improved droplet repellency of the outer filter, the improved performance of the inner filter for capture of ultrafine particles containing virus, and the improved touch and absorption performance of the inner filter by the ridges of the nanopatterned structure on the surface of the filter.

Hereinafter, the present disclosure will be described in detail through examples. However, the embodiments according to the present disclosure may be modified in many other forms, and the scope of the present disclosure should not be construed as being limited to the above-described embodiments. The embodiments of the present disclosure are provided to help those having ordinary skill in the corresponding technical field to understand the present disclosure completely and thoroughly.

### EXAMPLE

### 1. Outer Filter

### Comparative Example 1-1. Hydrophobic Nonwoven Filter

A nonwoven filter for use in outer filters for KF94 masks, made of polypropylene fibers from Hanil Synthetic Fiber Co., Ltd., is prepared.

### Example 1-1. Hydrophobic Nonwoven Filter Plasma Treated in Oxygen Atmosphere

A nonwoven filter for use in outer filters for KF94 masks, made of polypropylene fibers from Hanil Synthetic Fiber Co., Ltd., is prepared. The nonwoven filter is plasma treated at 40 mTorr in an oxygen atmosphere for 30 minutes to fabricate the nonwoven filter having ridges of nanopatterned structure on the fiber surface and bonding portions.

### Experimental Example 1-1. Determination of Ridges of Nanopatterned Structure

It is found through FIG. 2 that ridges of nanopatterned structure are formed through a scanning electron microscopy (SEM) image of the surface of the nonwoven filter of example 1-1.

### Experimental Example 1-2. Dipping Test

A dipping test is performed on the nonwoven filters of example 1-1 and comparative example 1-1 using a red aqueous solution.

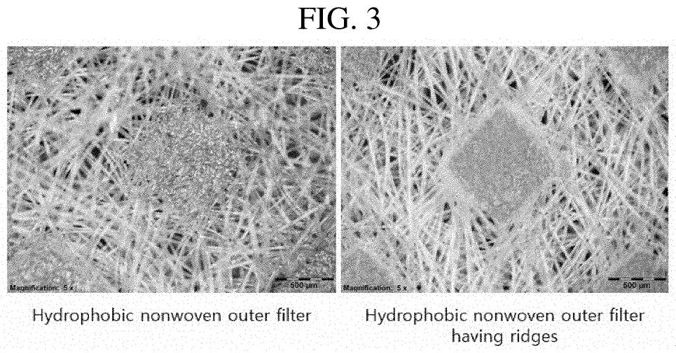

Referring to FIG. 3, any red residue is not observed in example 1-1, while a considerate amount of red residues at the boundaries between the fibers and the bonding portions is observed in comparative example 1-1.

### Experimental Example 1-3. Measurement of Surface Contact Angle

A surface contact angle when a water drop having the size of 1 mm to 5 mm is placed on example 1-1 and comparative example 1-1 is determined.

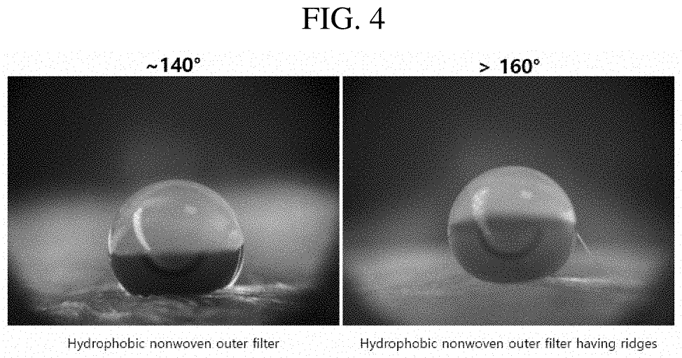

Referring to FIG. 4, it is found that the surface contact angle of comparative example 1-1 is less than 140°, and the surface contact angle of example 1-1 is 160° or more.

### Experimental Example 1-4. Determination of Droplet Repellency

To determine droplet repellency, after allowing droplets to bounce off the surface of example 1-1 and comparative example 1-1, water repellency is determined. It is found that a water drop having the diameter of 1 mm or more or a droplet having the diameter of a few tens to a few hundreds of micrometers gets bounced off.

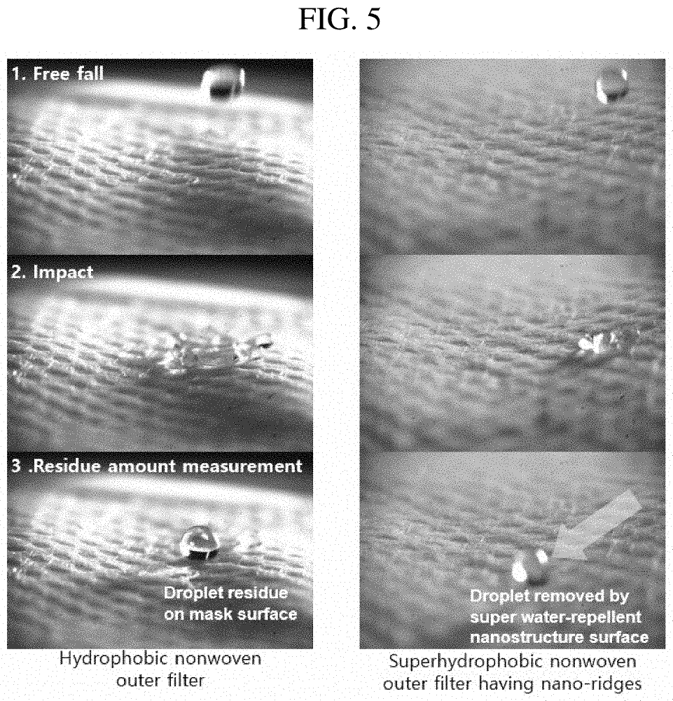

As shown in FIG. 5, it is found that example 1-1 has high water repellency.

### Experimental Example 1-5. Fluorescent Particle Coating Test

10 μM rhodamine 123 aqueous liquid from Sigma Aldrich is prepared and coated on the surface of example 1-1 and comparative example 1-1.

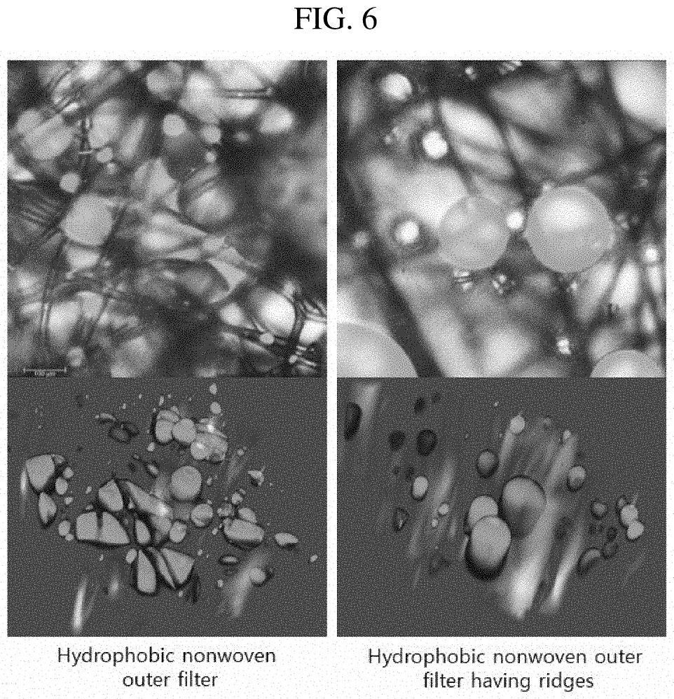

As shown in FIG. 6, it is found that example 1-1 has a smaller amount of residual fluorescent particles.

### 2. Intermediate Filter

### Comparative Example 2-1. Melt-Blown Filter

A filter for use in melt-blown intermediate filters for KF94 masks, made of polypropylene fibers from Hanil Synthetic Fiber Co., Ltd., is prepared.

### Example 2-1. Melt-Blown Filter Plasma Treated in Oxygen Atmosphere

A melt-blown intermediate filter for KF94 masks, made of polypropylene fibers from Hanil Synthetic Fiber Co., Ltd., is prepared. The melt-blown filter is plasma treated at 40 mTorr in an oxygen atmosphere for 30 minutes to fabricate a nonwoven filter having ridges of nanopatterned structure on the fiber surface.

### Experimental Example 2-1. Determination of Ridges of Nanopatterned Structure

It is found through FIG. 7 that ridges of nanopatterned structure are formed through an SEM image of the surface of the melt-blown filters of example 2-1 and comparative example 2-1.

### Experimental Example 2-2. Determination of Degree of Nanoparticle Capture

TiO₂ nanoparticles from Sigma Aldrich having the particle size of 50 to 100 nm are prepared, and the degree of adsorption onto the melt-blown filters of example 2-1 and comparative example 2-1 is determined through the SEM image.

It is found that in the case of example 2-1, the amount of adsorbed nanoparticles is overwhelmingly larger than that of comparative example 2-1.

### 3. Inner Filter

### Comparative Example 3-1. Hydrophilic Nonwoven Filter

A hydrophilic material made of Rayon fibers from Lenzing is prepared for an inner filter. The fiber is a few to a few tens of μm in thickness, and has a lobed cross section.

### Example 3-1. Hydrophilic Nonwoven Filter Plasma Treated in Oxygen Atmosphere

A hydrophilic inner filter made of Rayon fibers from Lenzing is prepared. The hydrophilic filter is plasma treated at 40 mTorr in an oxygen atmosphere for 30 minutes to fabricate a nonwoven filter having ridges of nanopatterned structure on the fiber surface.

### Example 3-2. Hydrophilic Nonwoven Filter Plasma Treated in Oxygen Atmosphere

A hydrophilic inner filter made of Rayon fibers from Lenzing is prepared. The hydrophilic filter is plasma treated at 40 mTorr in an oxygen atmosphere for 10 minutes to fabricate a nonwoven filter having ridges of nanopatterned structure on the fiber surface.

### Experimental Example 3-1. Determination of Ridges of Nanopatterned Structure

It is found through FIG. 9 that ridges of nanopatterned structure are formed through an SEM image of the surface of the hydrophilic filters of example 3-1 and comparative example 3-1.

Additionally, it is found that grooves similar to artificial silk fibers are formed on the surface of the fibers of example 3-1.

### Experimental Example 3-2. Evaluation of Liquid Absorption Time

The liquid absorption time of the hydrophilic filters of example 3-1 and comparative example 3-1 is evaluated.

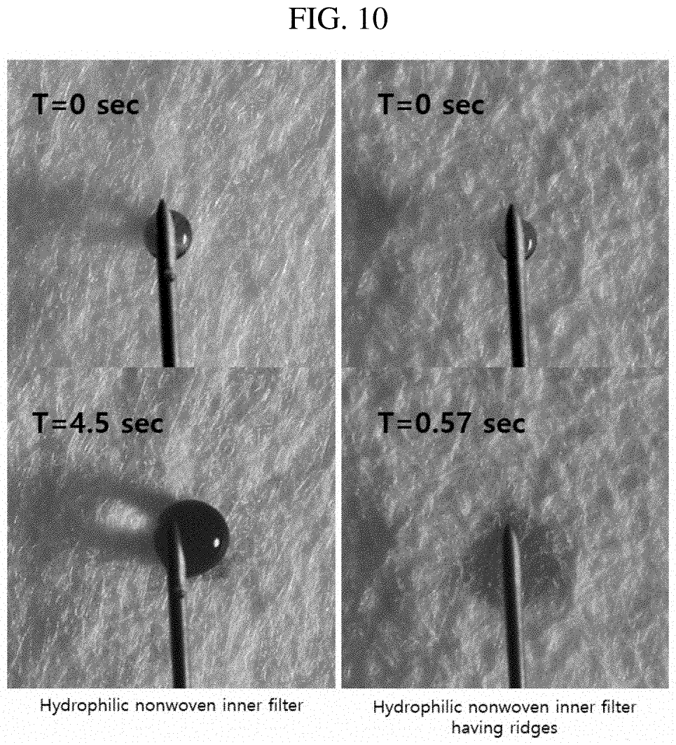

Referring to FIG. 10, it can be seen that the liquid absorption time of example 3-1 is 0.57 sec, and comparative example 3-1 did not completely absorb in 4.5 sec.

### Experimental Example 3-3. Evaluation of Liquid Absorption Time

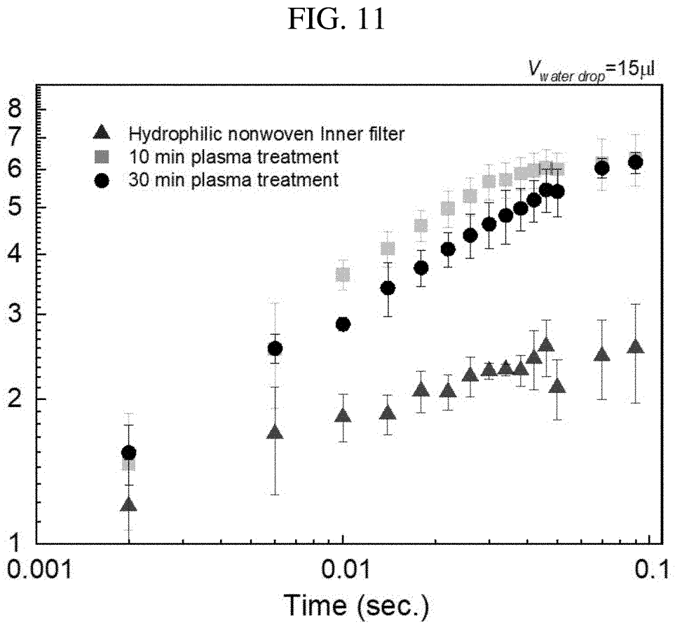

According to FIG. 11, a water drop spreading distance (a radius of a concentric ring formed by the spreading of a water drop) is measured on the surface of the hydrophilic filters of example 3-1, example 3-2 and comparative example 3-1. When a water drop (15 microliters) is placed on the hydrophilic nonwoven fabric without plasma treatment, the water drop spreads about 3.2 mm for 1 sec. However, as the plasma treatment time increases, the water drop spreads about 7.4 mm for 1 sec over the surface of the filter treated for 10 minutes and 30 minutes, and thus it can be seen that the water drop spreads further at least 2.3 times faster.

What is claimed is:

1. A super water-repellent anti-droplet mask, comprising:
an outer filter including a hydrophobic nonwoven fabric composed of bundles of hydrophobic fibers with first ridges that form a nanopatterned structure on a surface of the hydrophobic fibers;
an intermediate filter including a melt-blown nonwoven fabric composed of bundles of melt-blown fibers with second ridges that form a nanopatterned structure on a surface of the melt-blown fibers; and
an inner filter including a hydrophilic nonwoven fabric composed of bundles of hydrophilic fibers with third ridges that form a nanopatterned structure on a surface of the hydrophilic fibers.

2. The super water-repellent anti-droplet mask according to claim 1, wherein the hydrophobic nonwoven fabric further includes hydrophobic bonding portions to bind the bundles of hydrophobic fibers to form a web, and the hydrophobic bonding portions have fourth ridges that form a nanopatterned structure on a surface of the hydrophobic bonding portions.

3. The super water-repellent anti-droplet mask according to claim 1, wherein the outer filter including the hydrophobic nonwoven fabric has a surface contact angle of 160° or more on a surface of the outer filter.

4. The super water-repellent anti-droplet mask according to claim 1, wherein the first ridges form a nanopatterned structure of nanowalls or nanopillars.

5. The super water-repellent anti-droplet mask according to claim 1, wherein the first ridges are formed by plasma treatment.

6. The super water-repellent anti-droplet mask according to claim 5, wherein the plasma treatment of the first ridges is performed in the presence of at least one type of gas selected from O₂, CF₄, Ar, N₂ and H₂.

7. The super water-repellent anti-droplet mask according to claim 1, wherein the second ridges form a nanopatterned structure of nanowalls or nanopillars.

8. The super water-repellent anti-droplet mask according to claim 1, wherein the second ridges are formed by plasma treatment.

9. The super water-repellent anti-droplet mask according to claim 8, wherein the plasma treatment of the second ridges is performed in the presence of at least one type of gas selected from O₂, CF₄, Ar, N₂, and H₂.

10. The super water-repellent anti-droplet mask according to claim 1, wherein the third ridges form a nanopatterned structure of nanowalls or nanopillars.

11. The super water-repellent anti-droplet mask according to claim 1, wherein the third ridges are formed by plasma treatment.

12. The super water-repellent anti-droplet mask according to claim 11, wherein the plasma treatment of the third ridges is performed in the presence of at least one type of gas selected from O₂, CF₄, Ar, N₂ and H₂.

13. The super water-repellent anti-droplet mask according to claim 2, wherein the fourth ridges form a nanopatterned structure of nanowalls or nanopillars.

14. The super water-repellent anti-droplet mask according to claim 2, wherein the fourth ridges are formed by plasma treatment.

15. The super water-repellent anti-droplet mask according to claim 14, wherein the plasma treatment of the fourth ridges is performed in the presence of at least one type of gas selected from O₂, CF₄, Ar, N₂ and H₂.

16. A super water-repellent anti-droplet mask, comprising:
an outer filter including a hydrophobic nonwoven fabric composed of bundles of hydrophobic fibers with first ridges that form a nanopatterned structure on a surface of the hydrophobic fibers; and
an inner filter including a hydrophilic nonwoven fabric composed of bundles of hydrophilic fibers with third ridges that form a nanopatterned structure on a surface of the hydrophilic fibers.

17. The super water-repellent anti-droplet mask according to claim 16, wherein the hydrophobic nonwoven fabric further includes hydrophobic bonding portions to bind the bundles of hydrophobic fibers to form a web, and the hydrophobic bonding portions have fourth ridges that form a nanopatterned structure on a surface of the hydrophobic bonding portions.

18. A super water-repellent anti-droplet mask, comprising:
an outer filter including a hydrophobic nonwoven fabric composed of bundles of hydrophobic fibers with first ridges that form a nanopatterned structure on a surface of the hydrophobic fibers;
an intermediate filter including a melt-blown nonwoven fabric composed of bundles of melt-blown fibers; and
an inner filter including a hydrophilic nonwoven fabric composed of bundles of hydrophilic fibers with third ridges that form a nanopatterned structure on a surface of the hydrophilic fibers.

19. The super water-repellent anti-droplet mask according to claim 18, wherein the hydrophobic nonwoven fabric further includes hydrophobic bonding portions to bind the bundles of hydrophobic fibers to form a web, and the hydrophobic bonding portions have fourth ridges that form a nanopatterned structure on a surface of the hydrophobic bonding portions.
